(19) United States
(12) Patent Application Publication
(10) Pub. No.: US 2012/0086791 A1
(43) Pub. Date: Apr. 12, 2012

(54) Endoscope and Angiograph System with Options for Advantages in Signal-to-Noise and Disposability

(76) Inventors: Yu Zheng, West Jordan, UT (US); Dominic Massetti, San Jose, CA (US); Dale Edmondson, Sunnyvale, CA (US); Robbert Emery, Sunnyvale, CA (US)

(21) Appl. No.: 12/902,007

(22) Filed: Oct. 11, 2010

(51) Int. Cl. H04N 7/18

(52) U.S. Cl. 348/76; 348/E07.085

(57) ABSTRACT

An endoscope system of one aspect includes a probe including a CMOS image sensor or sensors, and a conductor or conductors for transmitting an image signal outward from the CMOS image sensor or sensors. The system also includes a connector system including one or more integrated circuits and/or connectors, receiving a signal from the CMOS image sensor or sensors and processing that signal. The system also includes a sensor power supply for the CMOS image sensor or sensors, and a remainder power supply for the remainder of the endoscope system. Other endoscope systems, angiographic systems, devices, and methods associated therewith are also disclosed.

### TECHNICAL FIELD

Embodiments of the present invention relate to an apparatus for endoscopic observation and surgery and, more particularly, to a device carrying an endoscopic or angiographic instrument with a solid-state image sensor.

### BACKGROUND INFORMATION

Endoscopic and laparoscopic surgical devices have become more commonly used in a wide range of procedures. Such devices typically are able to access a surgical site or view the interior of the human body through a natural body orifice or through a small incision. Among the functionalities commonly found in such devices is the ability to enable the surgeon to view the surgical site or surroundings, which is often remote and not visible to the naked eye.

Generally pre-existing endoscopes typically comprise a flexible outer tube having a lens at the distal end of the tube. Positioned within the tube are image sensing components and other components that transmit an imaging signal to and from the image sensor. While endoscopes that have been adapted for use with optical systems are known, such systems can be bulky and tend to be quite costly. The relatively large size of endoscopes can limit access to particular areas in a patient and contribute to the physical discomfort experienced by a patient during manipulation of the endoscope. Contributing to the high cost of endoscopes are the fabrication components which are generally expected to withstand harsh cleaning procedures. In addition, an endoscope faces challenges in that it may need considerable amounts of light to function well. Scopes typically are inserted into areas in near or absolute darkness. Scopes therefore frequently need some form of light source, as well as sensors with good low-light sensitivity. In addition, objects inserted into patients are sharply limited in the amount of heat they can exude; too much heat, and the scope itself will inflict discomfort and/or harm the patient. Accordingly, scopes typically operate at an acceptable level of heat while still managing sufficient power to function.

An allied field of endoscopy is angiography. Whereas endoscopy visually examines the inner tracts and conduits of internal organs such as esophagus, colon and stomach, angiography provides visual images of blood-flowing conduits and compartments such as arteries, veins, and heart chambers such as atriums and ventricles. For example, a medical practitioner may use an angiographic procedure to obtain real time or lag time images of a patient's blood vessel such as a coronary artery. In such an angiographic application, a patient suffering from coronary artery disease often needs to have the diseased vessel visually examined in order to identify the site of occlusion. Traditionally, an angiographic procedure utilizes either X-ray based fluoroscopy, Computer-assisted Tomography (“CT”), or is based on Magnetic Resonance Imaging (“MRI”). Basically, the patient is subject to a radiation that “sees through” the tissues. In order to contrast blood vessels against surrounding tissues for visualization, a radio-opaque contrast agent is injected into the blood circulation to make the blood vessels “stand out” against the tissue background. While widely used in modern medicine such as coronary catheterization, the traditional angiography is associated with several considerable risks to the patient. First, it subjects the patient (and the medical practitioner) to harmful levels of radiation. Moderate to high level of radiation is often used to produce good quality images of blood vessels. Second, the radio-opaque contrast agent sometimes causes severe allergic responses from the patient. Blood vessels that are subject to angiography are different from the body cavities (esophagus, colon, stomach, etc.) that are subject to endoscopy in several physiological aspects. Accordingly, the angiographic examination inside a blood vessel poses several unique challenges as compared with a traditional endoscopic procedure. In a traditional endoscopic procedure, air is often introduced to inflate the body cavity in order to assist visualization. This cannot be done to a blood vessel because the introduction of air into blood circulation will cause dangerous and often fatal air embolism to the patient.

### SUMMARY

Embodiments of the invention relate to a small, low-profile probe with high low-light sensitivity, connected to a system of exterior processing circuitry in one of several configurations, connected in turn to display and/or control mechanisms. The system seeks to optimize sensor performance by dedicating a specialized power source to the sensor, which reduces noise in the sensor-generated signal. It would be desirable to design smaller endoscopes, which may also be produced inexpensively, so that it would be economically feasible to have partially or completely “disposable” endoscopes. An embodiment of the invention further shifts many functions or components from the probe to the non-insertable portion of the system, making it possible to manufacture probes economically enough to render them optionally disposable, and to allow re-use of the bulk of the system (thus optionally disposing of the portion that would be sterilized for re-use, and retaining the rest to further cost savings and efficiency).

An alternate embodiment of the invention is a small, low-profile probe connected to a system of exterior processing circuitry in one of several configurations, connected in turn to display and/or control mechanisms. The probe is capable of being deployed inside a blood vessel as an alternative investigative technique to supplant the traditional angiography that relies on subjecting the patient to radiation and radio-opaque contrast agent. Aside from all the disclosures relating to the endoscopic application of embodiments of the present invention, another angiographic embodiment also includes a fluid injection port and conduit or other means to reduce the number of red cells in the localized viewing area inside a blood vessel.

It is an object of an embodiment of the present invention to provide an economical, optionally disposable endoscope system having a Complementary Metal Oxide Semiconductor (CMOS) solid-state image sensor for generating an image ready signal in an endoscopic or angiographic instrument adapted to view organ or tissue structures or foreign objects, in the body. By using a device with a small cross-section, high low-light sensitivity, and noise minimization configuration as set forth herein, the embodiment of the invention can provide a practical solution to the problems noted above. Moreover, while an embodiment of the invention was conceived in relation to medical applications, it can carry similar utility in any application—biological or otherwise (e.g., as a non-medical industrial or automotive boroscope, fiberscope, microscope, or the like)—that benefits from a small cross-section, high-sensitivity, low noise, low power solution.

Yet another object of an embodiment of the present invention is to provide varying forms of CMOS-sensor based scopes that can serve a variety of needs economically and efficiently, minimizing obstacles such as those set forth above. The embodiment thereby can serve practitioners' needs in a variety of contexts, and provide benefits from a business as well as a technical standpoint. In addition to a variety of specialty endoscopes, one embodiment enables integration of CMOS sensor image functions into existing surgical equipment, providing visibility in the body during surgical instrument use while realizing the benefits of the particular low-noise, low-profile, economical sensor system set forth herein.

Yet another object of an embodiment of the present invention is to reduce the power consumption in the insertable portion of a scope to a bare minimum, and to shift as many functions, objects, and space- or power-consuming components outside the insertable portion as possible. This object recognizes that a key goal of endoscope design is to reduce the profile of the insertable probe, reducing the impact on, discomfort to, and risk to the patient. By way of example, an embodiment may provide reduction of noise by utilizing a separate power source for the sensor, which can enable use of a sensor that uses less light, and less power, to operate than would otherwise be possible. Light introduced via fiber optics has the benefit of not having the heat-generating light source within the body. Disposable or rechargeable batteries mounted on portions of the system that remain outside the body or remote from the probe can offer additional options for disposability and flexibility.

Yet another object of an embodiment of the present invention is to facilitate the creation of a visually clear viewing area during scope operation. By way of example, an angiographic embodiment of the present invention may include a fluid injection port and conduit or other means to introduce a visually clear substance into the viewing area inside a blood vessel. Such introduction may substantially remove red blood cells from the viewing area, thereby rendering the viewing area visually accessible to the image sensor mounted on an angiographic instrument that is inserted into the blood vessel.

The above and still further objects, features and advantages of the present invention will become apparent upon consideration of the following detailed description of specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is an illustration of an endoscope system according to an embodiment of the invention.

FIG. 2 is an illustration of the tip of an embodiment of an endoscope probe that includes a lens, a sensor, sources of light and wires.

FIG. 3 is an illustration of an endoscope system according to an embodiment of the invention where the length of the endoscope system is shortened.

FIG. 4 is an illustration of an endoscope system according to an embodiment of the invention.

FIG. 5 is an illustration of a handheld endoscope system according to an embodiment of the invention.

FIG. 6 is an illustration of a hybrid endoscope system according to an embodiment of the invention.

FIG. 7 is an illustration of an endoscope system according to an embodiment of the invention where the endoscope system is substantially stabilized with regard to motion.

FIG. 8 is an illustration of an endoscope system according to an embodiment of the invention where the endoscope system is incorporated into a surgical device.

FIG. 9 is an illustration of the tip of an embodiment of a surgical device that includes a forceps structure, a surgical working member, an endoscopic probe with its lens and sensor elements.

FIG. 10A is an illustration of an angiographic probe according to an embodiment of the invention where a dilution fluid is not yet injected into a blood flow.

FIG. 10B is an illustration of an angiographic probe according to an embodiment of the invention where a dilution fluid has been injected into a blood flow.

FIG. 11A is an illustration of an angiographic probe according to an embodiment of the invention where a balloon is not yet expanded.

FIG. 11B is an illustration of an angiographic probe according to an embodiment of the invention where a balloon has been expanded.

FIG. 12 is an illustration of a multi-sensor angiographic probe according to an embodiment of the invention.

### DESCRIPTION OF THE PREFERRED EMBODIMENT

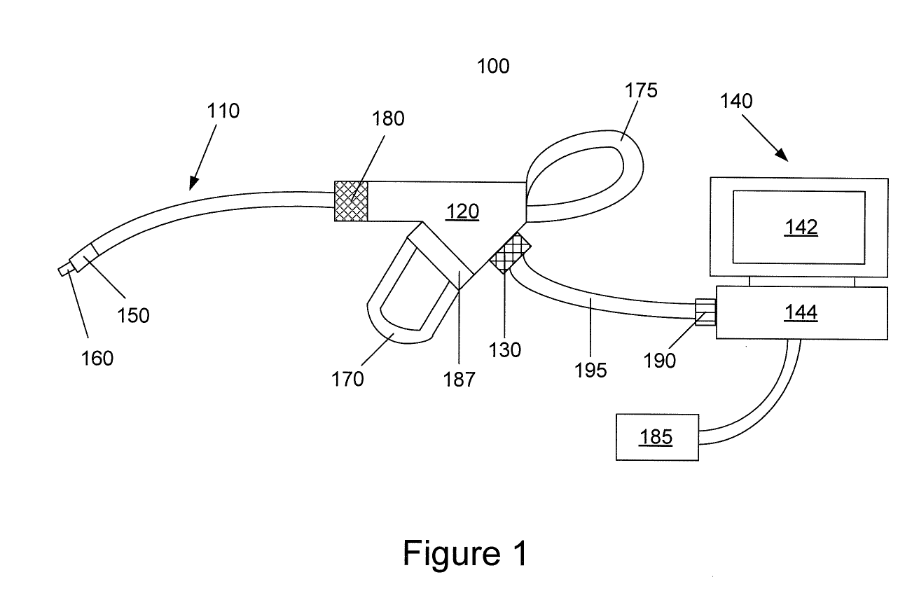

An endoscope system 100 according to a first embodiment of the present invention is shown in FIG. 1. It comprises an optionally disposable probe 110 for patient insertion, mounted on a core 120, connected to a processing system 130 and ultimately to a monitor/storage station 140 via a cable 195 and a plug 190.

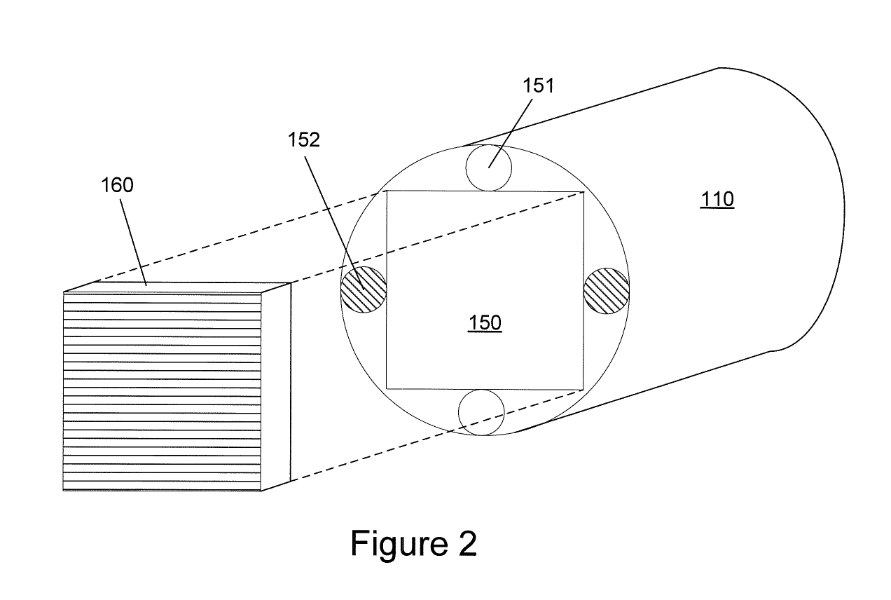

The probe 110 includes a CMOS image sensor 150 with minimal signal processing circuitry and enhanced low-light performance, such as the OV6930 brand image sensor, available from OmniVision Technologies, Inc., and a lens 160, mounted on a support. As shown in FIG. 2, the probe mounts a source of light 151, which may take various forms ranging from low heat on-probe sources (light-emitting diodes or other low-heat sources may be options, among other things) to an optical fiber, other optical waveguide, or other means of transmitting light generated elsewhere in the system; alternate forms of the system may rely on light from other sources. The probe may also include a device or means for changing the field of view (e.g., swiveling the sensor and/or extending/changing the position of the sensor). Hence, the probe may take a variety of forms, ranging from a simple rigid structure to a flexible, controllable instrument capable of “snaking” down a vessel or other passageway. The probe supports the wires 152 leading from the sensor and light source, as well as any additional mechanisms used to control the movement of the probe or sensor thereon. The entire probe is detachable and optionally disposable.

The objective lens elements 160 may be movable via a motorized focus control mechanism, as is known in the art, but are preferably fixed in position to give a depth of field providing an in focus image at all distances (from the barrel distal end) greater than a selected minimum in-focus distance. Fixed focus optics are more suitable to economical manufacture, as beneficial in design of disposable optics.

The probe connects to a scope core 120—a structure providing a framework to which other components can attach, as well as circuitry for connection of other components. For example, a hand grip handle 170 for an operator attaches to the scope core 120. A probe manipulation handle 175 may also attach to scope core 120 and be used to manipulate probe 110, e.g., advancement, retraction, rotation, etc. The scope core 120 includes a power source 180 for the sensor. This power source 180 is separate from another power source 185 used for the remainder of the system in order to reduce noise. If the probe 110 includes a device or means for changing the position of the sensor 150, the controls for that function can be in the scope core 120, the probe manipulation handle 175, or the hand grip handle 170, with keys on the exterior of these components. Power for the system (apart from the sensor) flows either from the monitor/storage station 140 or from a separate cell 187 connected to the scope core 120 or hand grip handle 170.

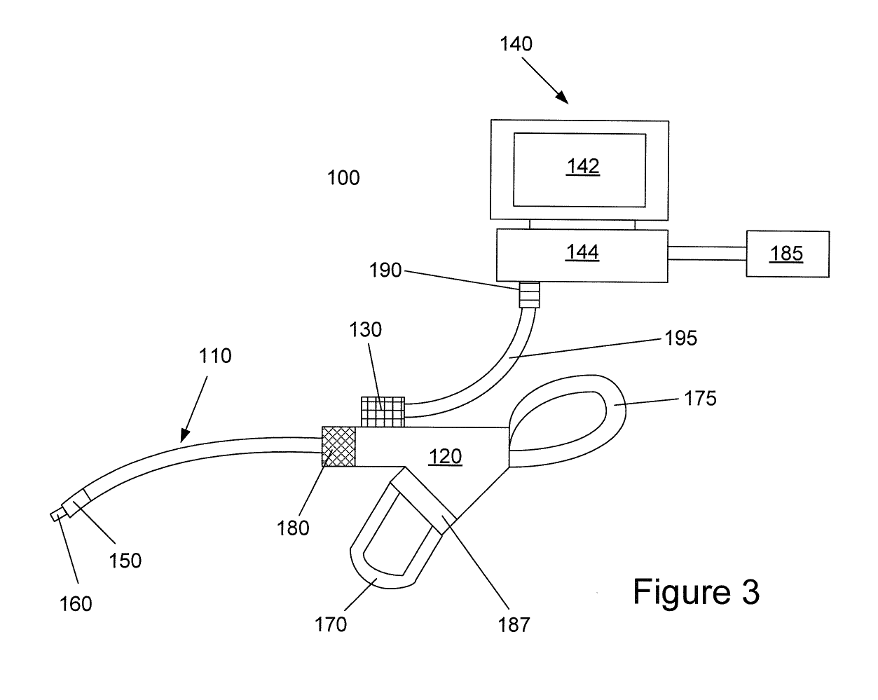

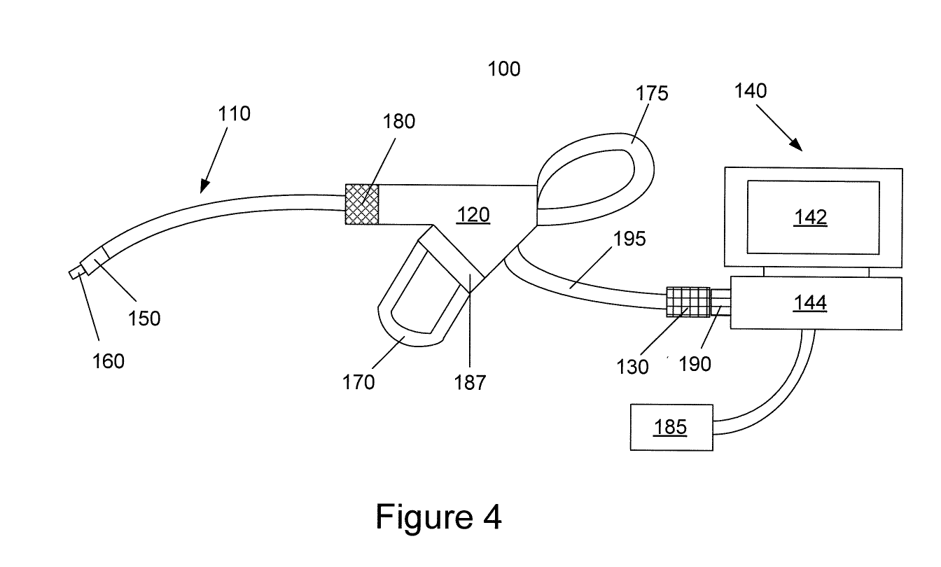

The signal from the probe 110, once it exits the body (or in non-medical applications, any other viewing site with space and other constraints), will pass through a processing/connector system 130, which is a flexible array of processor circuits that can perform a wide range of functions as desired. The processor circuitry can be organized in one or more integrated circuits and/or connectors between the same, and is housed in one or more modules and/or plugs along the pathway between the probe and the point at which the image will be viewed. Some embodiments utilize a scope core 120 as a point of attachment across which a connector system 130 may be mounted. In one embodiment as shown in FIG. 1, initial processing and analog to digital conversion is performed in a connector system module 130 mounted outside the scope core 120, possibly to the bottom in order to avoid lengthening the scope 100 more than necessary. That connector system module 130 is in turn connected by cable 195 to an end plug 190 attached to a monitor/storage station 140 where the image will be viewed. In another embodiment as shown in FIG. 3, the connector system module 130 is connected to the top side of the scope core 120 in order to avoid lengthening the scope 100 more than necessary. Other embodiments have more or fewer functions performed in a connector system as described, depending on the preferences and/or needs of the end user. A variety of cables 195 are used to link the various stages of the system. For instance, one possible link utilizing an LVDS (Low Voltage Differential Signaling) electrical interface currently used in automotive solutions may allow for up to 10 meters in length, while other options would have shorter reaches. Designers use different configurations depending on user preferences. As shown in FIG. 4, an embodiment includes a connector module 130 placed at the end of the cable 195 instead of on the scope core 120. Further, the final image signal converter integrated circuit chip is housed in a plug 190 designed to link the connector system 130 directly to the monitor/storage station 140.

The connector system 130 plugs into a monitor/storage station 140, including a view screen 142 and/or a data storage device 144. Standard desktop or laptop computers work for this purpose; accordingly, the device includes circuitry for converting the signal into a format capable of receipt by a standard video display device. If desired, the monitor/storage station 140 can include additional processing software. The monitor/storage station 140 is powered by an internal battery or a separate power source 185 as desired; its power flows upstream to run the parts of the device that are not run by the separate sensor power source 180.

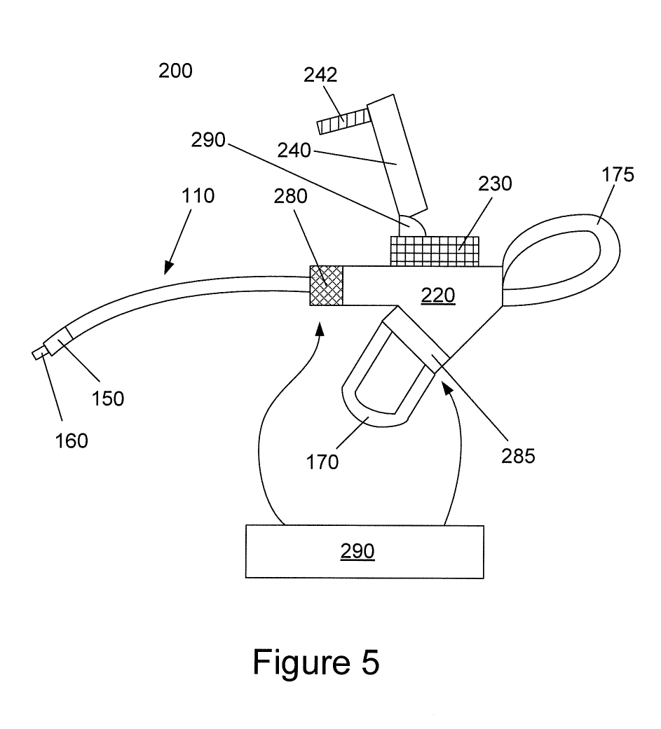

Alternate embodiments include a self-contained handheld configuration. Doctors may want scopes that integrate all functions, including a view screen, into one device with no separate monitor. As shown in FIG. 5, for this application (which is usable for, among other things, field scopes), one embodiment involves a handheld device 200 including a view screen 240 mounted on the scope core 220. The scope connector module 230 is mounted on the top of the scope core 220 to serve as a pedestal for the view screen 240. The view screen 240 is supported by a processing hardware 290, which includes an integrated circuit chip for conversion of the signal into a standard format. The view screen 240 is adjustable, and connects to a small removable storage device 242 (e.g., a thumb drive). The handheld device 200 is powered by separate rechargeable/replaceable sources—a sensor/probe power source 280 and another power source 285 for the processors and the view screen 240. Both power supplies have external links for recharging, which may be plugged into a docking station 290 when the device is not in use; alternately, the power may be supplied by batteries. If desired, this system may be modular—i.e., the view screen may be detachable and may be replaced by a cable if the user desires to add a separate monitor station.

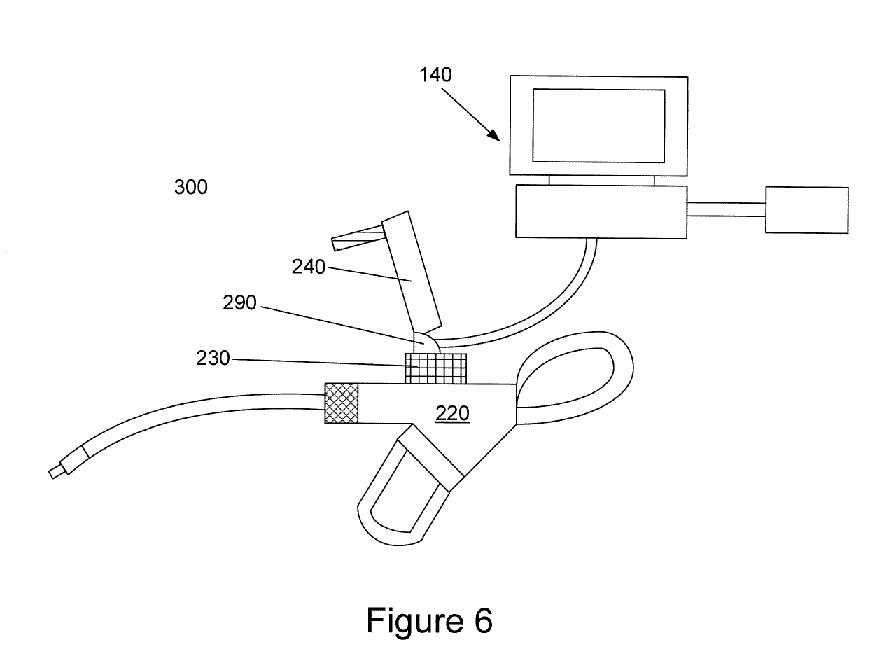

Another alternate embodiment, as shown in FIG. 6, involves a hybrid handheld scope 300 for circumstances in which users desire scopes designed for use by more than one operator. In one such embodiment, a hybrid system includes a view screen 240 on the handheld device and on a separate viewing monitor 140. This system is much like that described in a previous embodiment with the addition of a cable leading outward from the connector module to a monitor station.

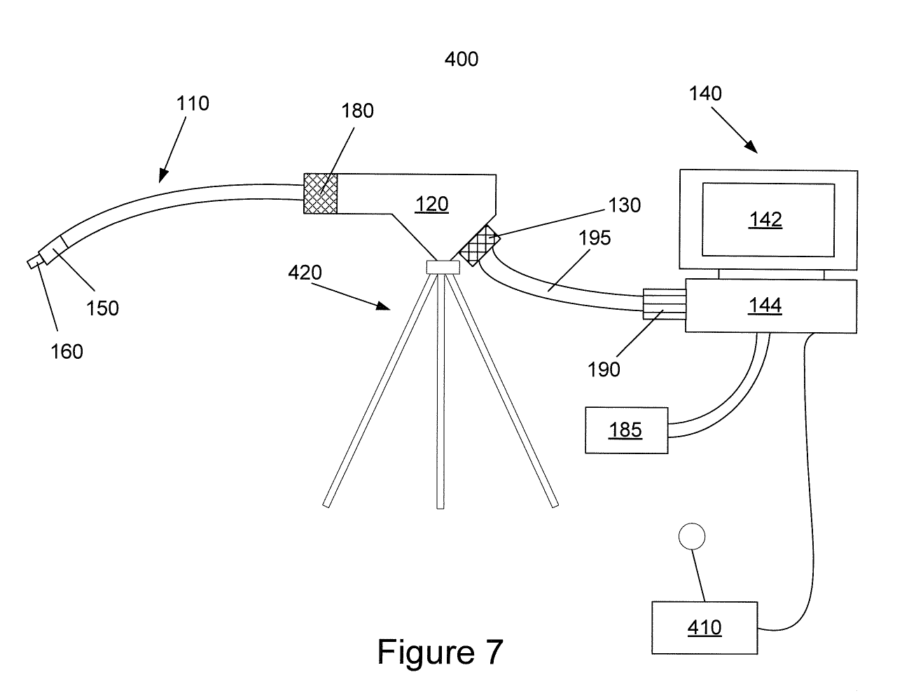

Another alternate embodiment includes a scope with detailed probe control and remote viewing for complex operations. This embodiment would serve users who want scopes with a high degree of probe movement—i.e., scopes capable of curving down a passageway. Examples of such a passageway include a blood vessel, a duct of gall bladder or pancreas, or an inner ear canal or in non-medical applications a tortuous conduit. To the extent that detailed movements become difficult to manage on a handheld device, this embodiment could supply benefits from having a fixed platform that does not shake or move relative to the patient while the scope is in use. As shown in FIG. 7, for a complex scope 400 of this kind, the probe's movement could be controlled from a monitor/storage station 140, either via a keyboard or via a pointing device 410 plugged in by a standard interface such as a Universal Serial Bus (USB). The control signals are transmitted down the cable 195 to the scope core 120, and from there to the probe 110. The scope core 120 attaches to a clamp or tripod 420. In this scenario, the patient will be immobile with the scope core 120 held in a fixed position relative to the patient. After inserting the probe 110 and fixing scope position, the operator controls probe movement from the monitor/storage station 140, observing the results as the probe 110 moves in the vessel or conduit.

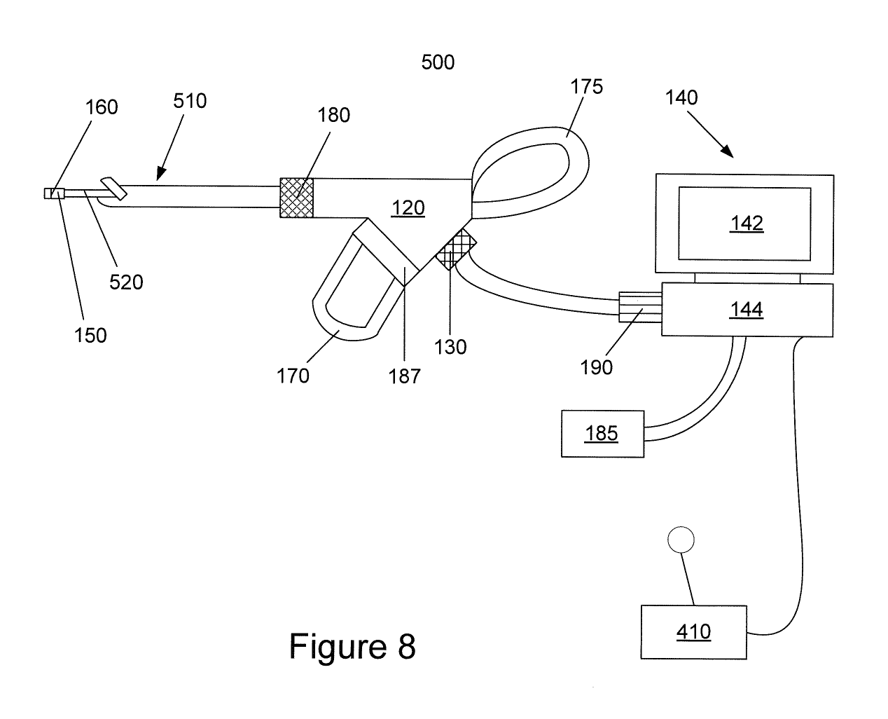

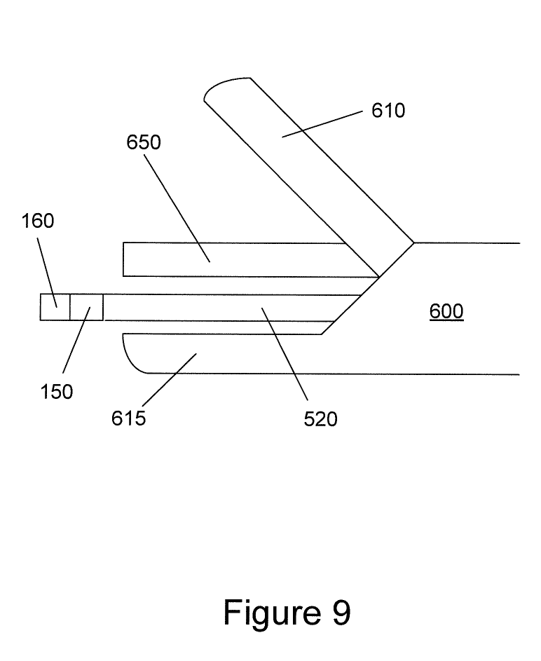

Another alternate embodiment includes a scope used as an add-on to other surgical devices. A representative embodiment mounts a small-profile sensor chip to a surgical device, producing a combined tool capable of both imaging and performing surgical operations. In those cases, the probe may be attached to an existing tool. The tool's existing framework serves as the scope core, with wires and other components mounted on it as necessary. Specifics vary depending on the tool to which the sensor is to be attached; a designer might consider manufacturing modular components that could be attached in various places depending on the situation. FIG. 8 shows an embodiment wherein a small-profile sensor 150, along with a lens 160, are mounted on a probe 520, which is further combined with a surgical device 500, wherein the probe 520 is positioned inside, or adjacent to an outer shaft 510 of, the surgical device 500. Possible elements common to surgical add-on embodiments include: a separate power source 180 for the sensor 150, to reduce noise; processor chips in a connector system 130 to be placed outside the insertion points (and to be reusable) at points between the probe 520 and the monitor station 140; a final format convertor chip/plug 190 to enable connection to a monitor station 140; and a monitor station 140 incorporating any desired processing software and/or probe movement control if desired. FIG. 9 shows a tip portion 600 of the outer shaft 510, which may possess various configurations according to surgical needs. Here, a forceps-like configuration is disclosed as one embodiment. The tip portion 600 includes an upper jaw 610 and a lower jaw 615. Probe 520 is situated between the upper jaw 610 and the lower jaw 615. A lens 160 and a sensor 150 are mounted on the probe 520. Sensor 150, lens 160, or probe 520 may be fixed inside the tip portion 600, or may be capable of movement such as advancement, retraction, or rotation. One or several surgical working members 650 may be situated adjacent to the probe 520. Here, only one surgical working member 650 is shown. The surgical working member 650 may be capable of one or several surgical functions, including irrigation, suction, puncturing, drilling, injection, cutting, cauterization, irradiation, electrical shock, etc.

An alternative embodiment includes a probe used as an optionally disposable angiographic probe. A representative embodiment includes a sensor, e.g., a CMOS imager, that includes a small-profile sensor chip at the tip of the angiographic probe. If a direct visualization device is deployed inside a blood vessel to directly “look inside” a blood vessel, then the blood vessel may be visually examined without either radiation or radio-opaque contrast agent, thereby eliminating the risks associated with traditional angiography. Blood contains a large number of red cells (4 to 5 million red cells per cubic millimeter of blood) that obstruct the viewing inside the blood vessel. Without removing or reducing the red cells in the viewing area, an angiographic imager will only “see” a blur of red cells. In order to visualize the blood vessel wall and the occlusive structures on the vessel wall (such as atherosclerosis related plaque structures), the red cells could be substantially reduced in the viewing area. Therefore, when a visual sensor is utilized in an angiographic device to view the inside of a blood vessel, the angiographic device may have the ability to reduce the red cells in the viewing area. Dilution of blood with a visually transparent agent (such as isotonic saline) may reduce the red cells in a localized viewing area.

The angiographic probe also includes an injection port that is used to dispense a dilution fluid to reduce the number of red cells in the viewing area during imaging. The dilution fluid can be a physiologic saline solution, a lactate ringer solution, or a serum or plasma fluid that is prepared from the patient's own blood. The nature of the dilution fluid is generally compatible with the patient's immune system, thereby substantially reducing the risk of allergic response from the patient. In order to facilitate viewing of the blood vessel wall, a volume of the dilution fluid is injected into the blood flow. The subsequent mixing of the blood and the dilution fluid substantially reduces the number of red blood cells in the vicinity of the sensor. The dilution fluid can be injected in any direction relative to the blood flow. Generally speaking, in order to produce sufficient dilution such that the number of red blood cells in the vicinity of the sensor is sufficiently reduced to allow direct viewing of the surrounding vessel wall, the dilution fluid will be injected in a direction that is against the blood flow. The resulting counter-flow mixing helps to increase the residence time of the dilution fluid in the viewing area. The dilution fluid can be injected in a bolus mode, a continuous mode, or an intermittent mode. The volume of the dilution fluid depends on the size of the blood vessel and the duration of the viewing period. Generally speaking, a larger blood vessel or a longer viewing period calls for more dilution fluid to be injected.

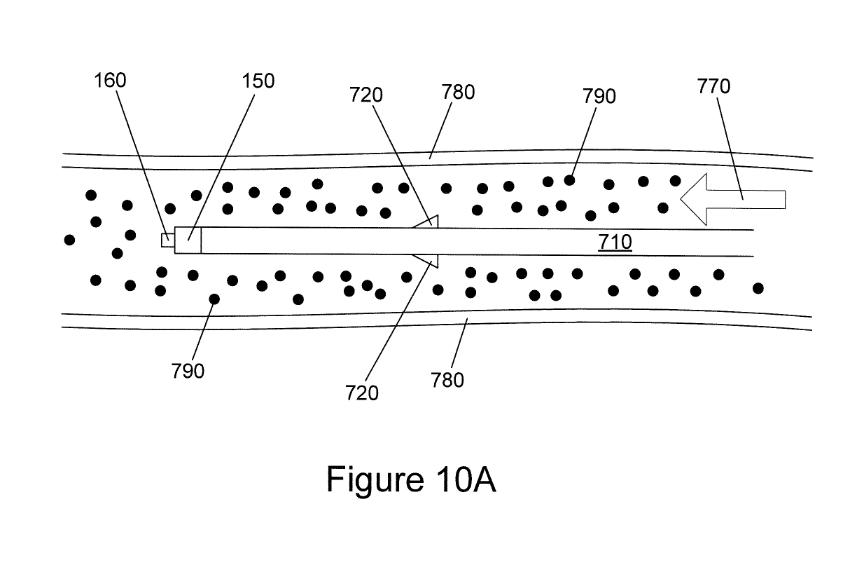

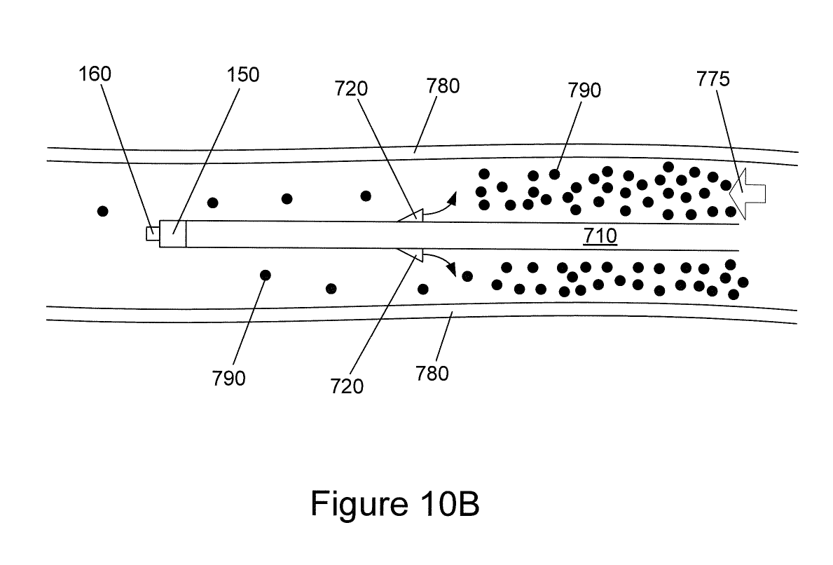

FIGS. 10A and 10B show an embodiment of an angiographic probe 710. Here, the probe 710 is introduced into the lumen of a blood vessel 780, along the direction of blood flow 770. A sensor 150 and a lens 160 are mounted at the tip of the probe 710. The probe 710 includes one or several injection ports 720, through which a dilution fluid is introduced into the lumen of the blood vessel 780. As shown in FIG. 10A, before the injection of the dilution fluid, the lumen of the blood vessel 780 is filled with red blood cells 790. The presence of a substantial number of red blood cells 790 in the vicinity of the sensor 150 hinders a direct viewing inside the blood vessel 780. When a dilution fluid is injected into the lumen of the blood vessel 780 through one or several injection ports 720, as shown in FIG. 10B, the amount of red cells 790 in the vicinity of the sensor 150 may be substantially reduced to allow direct viewing inside the blood vessel 780. In one example, the dilution fluid is injected in a direction that is substantially against the blood flow, resulting in a reduced blood flow 775, thereby prolonging the dilution effect in the vicinity of the sensor 150.

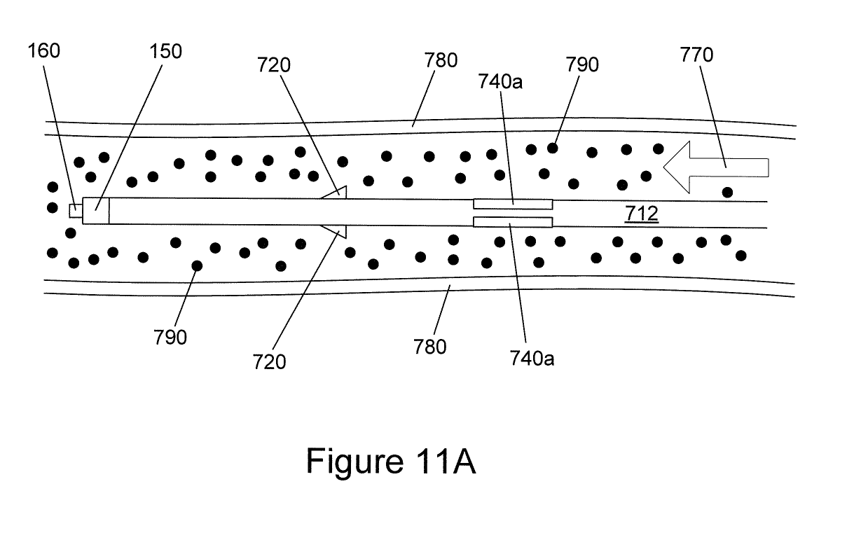

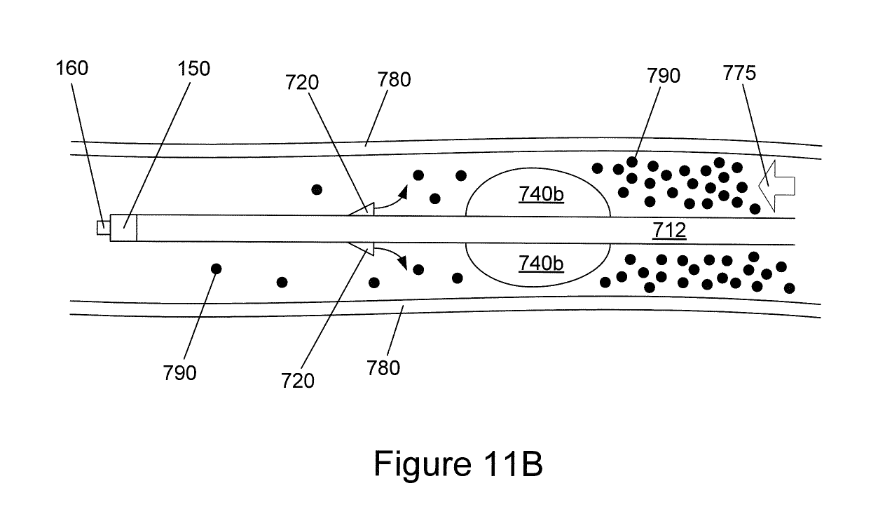

FIGS. 11A and 11B show an embodiment of a balloon angiographic probe 712. Compared with the angiographic probe 710 in FIGS. 10A and 10B, the balloon angiographic probe 712 further includes an inflatable balloon element 740a. FIG. 11A depicts the balloon angiographic probe 712 before viewing. Here, a dilution fluid is not yet injected, and the inflatable balloon element 740a is in a collapsed state. The vicinity of the sensor 150 has a substantial number of red blood cells 790, thereby hindering a direct viewing inside the blood vessel 780. As shown in FIG. 11B, to initiate viewing inside the blood vessel 780, the balloon element 740b is inflated to an expanded state, thereby slowing down blood flow 775. Further, the injection of a dilution fluid through one or several injection ports 720 substantially clears the red blood cells 790 from the vicinity of the sensor 150. Accordingly, a relatively clear viewing of the lumen of the blood vessel 780 may be achieved.

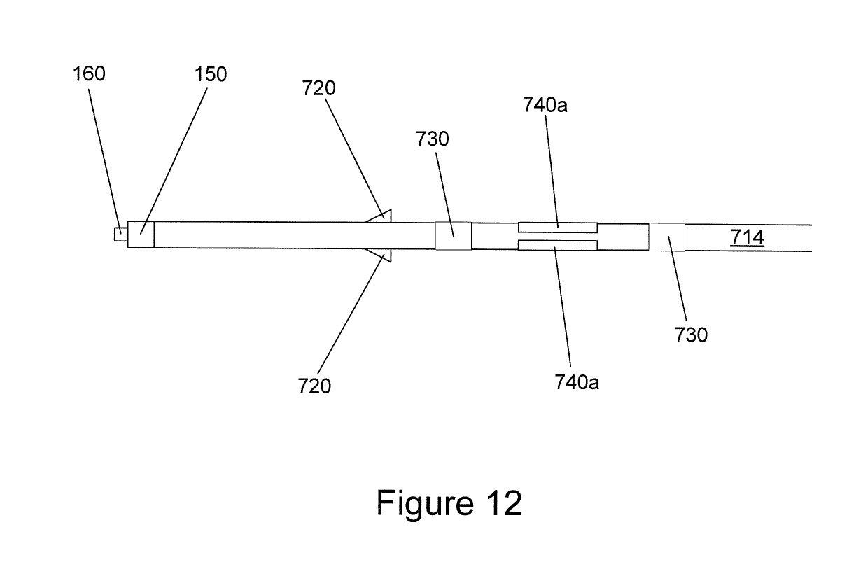

FIG. 12 shows an embodiment of a multi-sensor angiographic probe 714. Compared with the balloon angiographic probe 712 in FIGS. 11A and 11B, the multi-sensor angiographic probe 714 includes multiple sensor elements 730 that possess a side viewing capability. The inclusion of multiple sensor elements 730 allows a comprehensive viewing inside a blood vessel. Here, two sensor elements 730 are positioned on both sides of the inflatable balloon element 740a. This permits a medical practitioner to accurately position the inflatable balloon element 740a to a desirable location, e.g., an occlusive atherosclerosis plaque inside a coronary artery. After accurately positioning the inflatable balloon element 740a to the desired location, the medical practitioner expands the inflatable balloon element 740a for therapeutic purposes, such as a stent deployment in a percutaneous coronary intervention to treat acute myocardial infarction.

It will be appreciated that the endoscope, in each of the embodiments described herein, provides visualization or organ structures, tissue structures, prostheses and other foreign objects within the body, and all are adapted to be inserted through any portal into the body. Portal, as used herein, means any incised or natural opening providing access into the body. Alternatively, as previously mentioned, the scopes of each embodiment may be used in non-medical applications, such as industrial or automotive applications. CMOS image sensor, as used herein includes all solid state integrated circuits fabricated by the well known CMOS process producing chips having a plurality of pixels for converting image light energy into electrical image signal energy. A CMOS image sensor pixel, as used herein, means a CMOS image sensor picture element, usually occupying a defined region in a two dimensional array, for gathering light in that region. For color images, a red pixel, a green pixel, and a blue pixel occupy three sub regions within a color pixel region and red, green and blue color optical filters are incorporated into a color mosaic filter element and disposed adjacent to the respective CMOS image sensor pixel sub regions.

In as much as the present invention is subject to various modifications and changes in detail, the above description of a preferred embodiment is intended to be exemplary only and not limiting. It is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. An endoscope system including:
a probe including a Complementary Metal Oxide Semiconductor (CMOS) image sensor or sensors, and a conductor or conductors to transmit an image signal outward from the CMOS image sensor or sensors;
a connector system including one or more of integrated circuits and connectors, to receive a signal from the CMOS image sensor or sensors and to process the signal;
a sensor power supply for the CMOS image sensor or sensors; and
a remainder power supply for a remainder of the endoscope system.

2. An endoscope system of claim 1, wherein a linkage between the one or more of the integrated circuits and the connectors and the CMOS image sensor or sensors passes through a scope core or a framework on which the probe is mounted.

3. An endoscope system of claim 1, further including:
a circuitry that receives a signal from the connector system and converts the signal into a format for reception by a standard video system; and
a viewing screen supported by the circuitry for viewing the image generated by the CMOS image sensor or sensors.

4. An endoscope system of claim 3, wherein the endoscope system is capable of being held by hand, and further including a handgrip that is attached to or is enclosed by a scope core or a framework.

5. An endoscope system of claim 1, further including:
a monitor station that is remote from a scope core or a framework, wherein the monitor station further includes a circuitry supporting a view screen or a screen for viewing the image generated by the CMOS image sensor or sensors; and
a link between the connector system and the monitor station.

6. An endoscope of claim 5, wherein the probe and any support framework that is distinct from the monitor station or any connection system thereto are capable of being held by hand.

7. An endoscope system of claim 1, wherein the probe, which includes the CMOS image sensor or sensors, is detachable and disposable.

8. An endoscope system of claim 1, further including one or more mechanisms for controlling position and/or view angle of the CMOS image sensor or sensors that are mounted on the probe, such that the CMOS sensor or sensors are capable of changing position in a body of an investigative subject at direction of a user, thereby offering views of differing portions of the investigative subject.

9. An endoscope system of claim 8, wherein the one or more mechanisms for controlling the position and/or the view angle of the CMOS image sensor or sensors are contained at a remote viewing station.

10. An endoscope system of claim 9,
wherein a scope core or a framework is capable of being handheld;
wherein the one or more mechanisms for controlling the position and/or the angle of the CMOS image sensor or sensors are contained in an attached handgrip; and
wherein at least one surface of the one or more mechanisms is on an external portion of the attached handgrip such that the one or more mechanisms are capable of being manipulated by the user.

11. An endoscope system of claim 1, wherein the sensor power supply includes a battery, and wherein the remainder of the endoscope system is powered from a standard wall outlet.

12. An endoscope system of claim 1, wherein the probe includes a light source that is capable of providing sufficient light to allow operation of the CMOS image sensor or sensors.

13. An endoscope system of claim 1, wherein the probe includes a mechanism for transmitting light from a remote light source to a viewing site.

14. An endoscope system including:
a probe including a Complimentary Metal Oxide Semiconductor image sensor or sensors;
a mechanism to transmit a signal generated by the CMOS image sensor or sensors, said mechanism including a wire or wires that run along a framework of a surgical device and/or is sealed for protection;
a connector system including one or more of integrated circuits and connectors, wherein the connector system is to receive a signal from the CMOS image sensor or sensors, and is to process the signal;
a viewing station;
a link between the connector system and the viewing station;
a sensor power source for the CMOS image sensor or sensors; and
a remainder power source for a remainder of the endoscope system;
wherein the probe is attached to the surgical device.

15. An endoscope system of claim 14, wherein the probe is detachable and disposable.

16. An endoscope system of claim 14, further including one or more control mechanisms for changing a position and/or a viewing angle of the probe and/or the CMOS image sensor or sensors.

17. An angiographic system comprising:
a probe including a Complimentary Metal Oxide Semiconductor image sensor or sensors, and a conductor or conductors to transmit an image signal outward from the CMOS image sensor or sensors;
a connector system including one or more of integrated circuits and connectors, to receive a signal from the CMOS image sensor or sensors and to process the signal;
a sensor power supply for the CMOS image sensor or sensors;
a remainder power supply for a remainder of the angiographic system; and
one or more injection ports to inject a fluid into a blood circulation to reduce a number of red blood cells in a vicinity of the CMOS image sensor or sensors during viewing.

18. An angiographic system of claim 17, further including:
a circuitry to receive a signal from the connector system and to convert the signal into a format for reception by a standard video system; and
a viewing screen supported by the circuitry to view the image generated by the CMOS image sensor or sensors.

19. An angiographic system of claim 17, further including:
a monitor station that is remote from a scope core or a framework, wherein the monitor station further includes a circuitry supporting a view screen or a screen for viewing an image generated by the CMOS image sensor or sensors; and
a link between the connector system and the monitor station.

20. An angiographic system of claim 17, wherein an injection port is oriented such that it injects the fluid substantially against a direction of a natural blood flow inside a blood vessel that is under investigation.

21. An angiographic system of claim 20, further including at least one collapsible balloon element.

22. An angiographic system of claim 21, further including at least one side-viewing sensor element on at least one side of the collapsible balloon element.

23. An angiographic system of claim 17, further including at least one side-viewing sensor element.

24. An angiographic system including:
a probe including a Complementary Metal Oxide Semiconductor image sensor or sensors;
a mechanism to transmit a signal generated by the CMOS image sensor or sensors, said mechanism including a wire or wires that run along a framework of a surgical device and/or is sealed for protection;
a connector system including one or more of integrated circuits and connectors, wherein the connector system is to receive a signal from the CMOS image sensor or sensors, and is to process the signal;
a viewing station;
a link between the connector system and the viewing station;
a sensor power source for the CMOS image sensor or sensors; and
a remainder power source for a remainder of the angiographic system;
one or more injection ports to inject a fluid into a blood circulation to reduce a number of red blood cells in a vicinity of the CMOS image sensor or sensors during viewing;
wherein the probe is attached to the surgical device.

25. An angiographic system of claim 24, further including at least one collapsible balloon element.
